(19) United States
(12) Patent Application Publication
(10) Pub. No.: US 2014/0233228 A1
(43) Pub. Date: Aug. 21, 2014

(54) Lighting Fixture

(71) Applicant: Toshiba Lighting & Technology Corporation, Yokosuka-shi (JP)

(72) Inventors: Shigetoshi Komiyama, Yokosuka-shi (JP); Yasuhiro Sano, Yokosuka-shi (JP)

(73) Assignee: Toshiba Lighting & Technology Corporation, Yokosuka-shi (JP)

(21) Appl. No.: 14/031,825

(22) Filed: Sep. 19, 2013

(30) Foreign Application Priority Data
Feb. 18, 2013 (JP) 2013-029525

(51) Int. Cl. F21V 21/005; F21S 4/00

(52) U.S. Cl. CPC F21V 21/005; F21S 4/003
USPC 362/235

(57) ABSTRACT

According to one embodiment, there is provided a lighting fixture including a light source module and a support unit. The light source module includes a case which has the shape of a tube extending in a first direction, includes an opening, a substrate on which plural light sources are provided, and which is held in the case so that the plural light sources face the side opposite to the opening, and a mounting plate which is held by the case while being inserted between the opening and the substrate and is thermally connected to the substrate. The support unit includes a support plate which supports the light source module, and a frame which surrounds the outer edge of the support plate. An end portion of the light source module in the first direction is covered with the frame. The respective light sources are not covered with the frame.

### CROSS-REFERENCE TO RELATED APPLICATIONS

This application is based upon and claims the benefit of priority from Japanese Patent Application No. 2013-029525, filed on Feb. 18, 2013; the entire contents of which are incorporated herein by reference.

### FIELD

Embodiments described herein relate generally to a lighting fixture.

### BACKGROUND

There is a lighting fixture that is mounted on the ceiling or the like and illuminates a room. As such a lighting fixture for a room, there is a lighting fixture that includes a light source module and a support unit supporting the light source module. For example, a light-emitting element such as an LED or the like is used as a light source in the light source Module. The light source module includes, for example, a substrate on which a plurality of light sources are disposed so as to be lined up and a case that holds the substrate. The substrate has, for example, a rectangular shape, and the respective light sources are lined up, for example, in the longitudinal direction of the substrate. The light source module is, for example, long. Accordingly, a large light-emitting area that is suitable for the illumination in a room can be obtained.

There is a case in which a portion having low brightness is formed, for example, between an end portion of the light source module in the longitudinal direction and the support unit in the above-mentioned lighting fixture. Such a portion having low brightness causes, for example, the deterioration of a light distribution property and the deterioration of design.

### BRIEF DESCRIPTION OF THE DRAWINGS

FIGS. 1A and 1B are schematic views showing a lighting fixture according to an embodiment;

FIGS. 2A and 2B are schematic perspective views showing a support unit according to the embodiment;

FIGS. 3A and 3B are schematic views showing a light source module according to the embodiment;

FIGS. 4A and 4B are schematic perspective views showing a part of a support plate and a part of a mounting plate according to the embodiment;

FIGS. 5A and 5B are schematic perspective views showing a part of the support plate and a part of the mounting plate according to the embodiment;

FIG. 6 is a partial cross-sectional view schematically showing a part of the lighting fixture according to the embodiment; and

FIGS. 7A to 7C are schematic cross-sectional views showing another light source module according to the embodiment.

### DETAILED DESCRIPTION

According to an embodiment, there is provided a lighting fixture that includes a light source module and a support unit. The light source module includes a case, a substrate, and a mounting plate. The case has the shape of a tube extending in a first direction, includes an opening extending in the first direction, and has light transmissivity. A plurality of light sources are provided on the substrate so as to be lined up, and the substrate is held in the case so that the plurality of light sources face the side opposite to the opening. The mounting plate is held by the case while being inserted between the opening and the substrate and is thermally connected to the substrate. The support unit includes a support plate and a frame. The support plate supports the light source module, and is thermally connected to the mounting plate. The frame surrounds the outer edge of the support plate, and has light reflectivity. An end portion of the light source module in the first direction is covered with the frame. The respective plurality of light sources are not covered with the frame.

Each embodiment will be described below with reference to the drawings.

Meanwhile, the drawings are schematic drawings or conceptual drawings. Relationships between the thicknesses and widths of the respective portions, ratios between the sizes of the respective portions, and the like are not necessarily the same as those in reality. Further, even when the same portions are shown, dimensions or ratios may be shown so as to differ in the respective drawings.

Meanwhile, in this specification and the drawings, the same elements as the elements described above in the already-shown drawings are denoted by the same reference numerals and the detailed description thereof will be appropriately omitted.

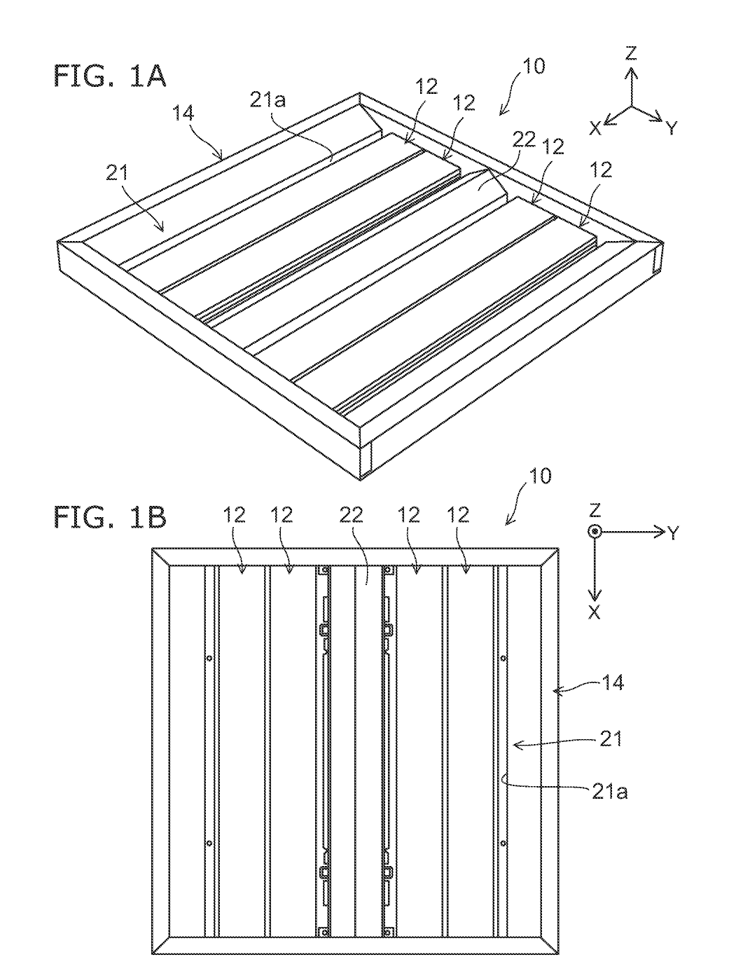

FIGS. 1A and 1B are schematic views showing a lighting fixture according to an embodiment.

FIG. 1A is a schematic perspective view of a lighting fixture 10, and FIG. 1B is a schematic plan view of the lighting fixture 10.

As shown in FIGS. 1A and 1B, the lighting fixture 10 includes light source modules 12 that emit light, and a support unit 14 that supports the light source module 12. For example, a plurality of light source modules 12 are provided in the lighting fixture 10. The support unit 14 supports the respective plurality of light source modules 12. In this embodiment, four light source modules 12 are provided in the lighting fixture 10. The number of the light source modules 12 provided in the lighting fixture 10 is not limited to four, and may be one or four or more. The number of the light source modules 12 is arbitrary.

The lighting fixture 10 is mounted on the ceiling in a room so that, for example, the respective light source modules 12 face down. For example, metal fittings such as hanging bolts are mounted on the support unit 14. The lighting fixture 10 is mounted on the ceiling by these metal fittings. Accordingly, the lighting fixture 10 illuminates a room by light emitted from the respective light source modules 12. Meanwhile, the lighting fixture 10 may be mounted not only on the ceiling but also on the wall or the like.

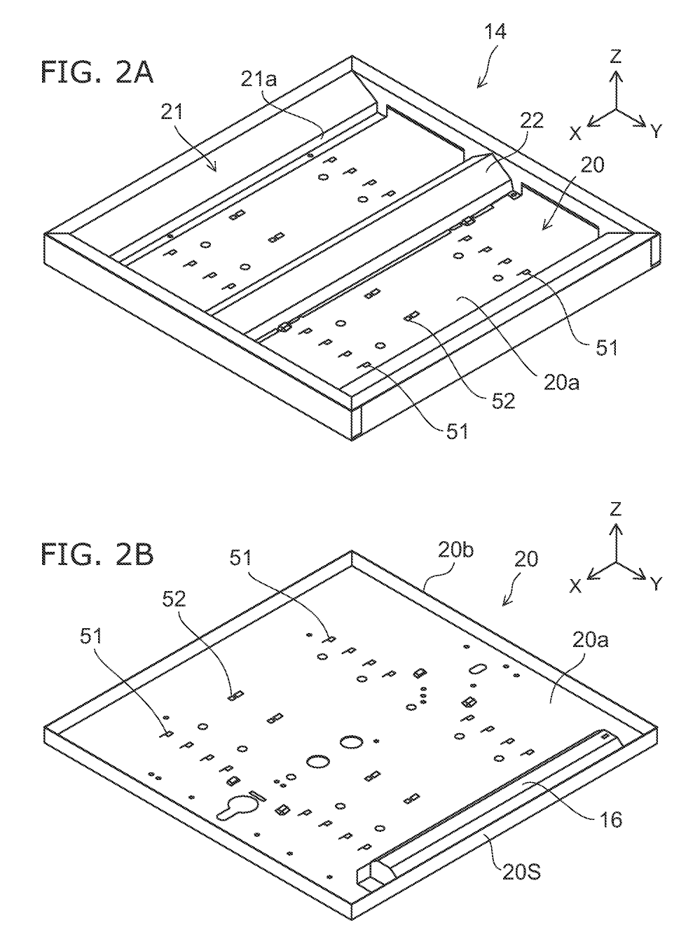

FIGS. 2A and 2B are schematic perspective views showing the support unit according to the embodiment.

As shown in FIG. 2A, the support unit 14 includes a support plate 20, a frame 21, and a cover 22. FIG. 2B schematically shows a state of the support unit 14 in which the frame 21 and the cover 22 are removed.

As shown in FIGS. 2A and 2B, the support plate 20 includes a support surface 20a that supports the respective light source modules 12. Here, one direction parallel to the support surface 20a is referred to as an X-axis direction. A direction, which is parallel to the support surface 20a and perpendicular to the X-axis direction, is referred to as a Y-axis direction. A direction, which is perpendicular to the X-axis direction and the Y-axis direction, is referred to as a Z-axis direction. In other words, the Z-axis direction is a direction perpendicular to the support surface 20a.

The shape of the support plate 20, which is projected on a plane (X-Y plane) parallel to the support surface 20a, is, for example, a quadrangular shape. In other words, the shape of the support plate 20, when the support plate 20 is seen in the Z-axis direction, is, for example, a quadrangular shape. In this embodiment, the shape of the support plate 20 (the shape of the support surface 20a) is, for example, a square shape. In this embodiment, a pair of sides of the support surface 20a are parallel to the X-axis direction. Further, the other pair of sides of the support surface 20a are parallel to the Y-axis direction. The length of one side of the support surface 20a is in the range of, for example, about 400 mm to 800 mm.

The shape of the support plate 20 is not limited to a square shape, and may be, for example, a rectangular shape. The shape of the support plate 20 may be, for example, another polygonal shape, and may be a circular shape, an oval shape, or the like. The shape of the support plate 20 may be arbitrary. For example, a metal material, such as iron, aluminum, or stainless steel, is used for the support plate 20. The support plate 20 may be made of, for example, a resin material having high thermal conductivity such as carbon fiber.

The shape of the lighting fixture 10, when the lighting fixture 10 is projected on the X-Y plane, is substantially the same as the shape of the support plate 20. In this embodiment, the shape of the lighting fixture 10, when the lighting fixture 10 is projected on the X-Y plane, is a square shape. The length of one side of the lighting fixture 10 is in the range of, for example, about 400 mm to 800 mm. The shape of the lighting fixture 10, when the lighting fixture 10 is projected on the X-Y plane, is arbitrary. The shape of the lighting fixture 10, when the lighting fixture 10 is projected on the X-Y plane, may be different from the shape of the support plate 20.

The support plate 20 includes a rib 20b formed along the outer edge of the support surface 20a. The rib 20b has, for example, the shape of a loop that surrounds the support surface 20a. The rib 20b extends in a direction crossing the support surface 20a. The rib 20b extends in, for example, the Z-axis direction. For example, the rib 20b is formed by bending a part of the outer edge of the support plate 20. Accordingly, the strength of the support plate 20 can be increased. The extending direction of the rib 20b is not limited to the Z-axis direction, and may be an arbitrary direction crossing the support surface 20a. The rib 20b may not necessarily surround the entire circumference of the support surface 20a. The rib 20b may be discontinuous along the entire circumference of the support surface 20a. In other words, a plurality of ribs 20b may be formed on the support plate 20 along the outer edge of the support surface 20a.

The support plate 20 includes a side surface 20s that extends in a direction crossing the support surface 20a. The side surface 20s is, for example, the side surface of the rib 20b.

The lighting fixture 10 further includes a power circuit 16 that supplies power to each of the light source modules 12. For example, the power circuit 16 is provided on the support surface 20a, and is mounted on the support plate 20 by screw-fastening or the like. The power circuit 16 has, for example, an elongated shape. The extending direction of the power circuit 16 is parallel to, for example, the X-axis direction. For example, the power circuit 16 is disposed parallel to one side of the support surface 20a that is parallel to the X-axis direction. Further, the power circuit 16 is disposed along one side of the support surface that is parallel to the X-axis direction. The shape and disposition of the power circuit 16 are not limited thereto, and may be arbitrary.

For example, the power circuit 16 converts power, which is supplied from the outside, to a voltage or current corresponding to the light source module 12, and supplies the voltage or current to the light source module 12. As power is supplied from the power circuit 16, the light source module 12 turns on a light source and emits light. Meanwhile, since the power circuit 16 is provided as necessary, the power circuit 16 may be omitted. For example, the power circuit 16 may be provided separately from the lighting fixture 10.

The frame 21 surrounds the outer edge of the support plate 20. The frame 21 has the shape of, for example, a substantially quadrangular loop. The frame 21 is formed by bending, for example, a plate-like member. The frame 21 has, for example, a hollow shape. For example, a metal material, such as iron, aluminum, or stainless steel, is used for the frame 21. The frame 21 has light reflectivity. For example, paint having high light reflectivity, such as white paint, is applied on the frame 21. The frame 21 is mounted on the support plate 20 by, for example, screw-fastening or the like and covers a part of the outer peripheral portion of the support surface 20a. Accordingly, for example, the design of the lighting fixture 10 can be improved. The frame 21 covers, for example, the side surface 20s of the support plate 20. Therefore, for example, the design of the lighting fixture 10 can be further improved. Further, the frame 21 covers and hides, for example, the power circuit 16 or wires formed between the respective light source modules 12 and the power circuit 16. Accordingly, for example, the insulating property of the lighting fixture 10 can be improved.

The frame 21 includes, for example, a substantially quadrangular opening 21a. The opening 21a allows, for example, a part of the support surface 20a to be exposed to the outside. The opening 21a allows, for example, the respective light source modules 12, which are mounted on the support plate 20, to be exposed to the outside. Further, a pair of portions, which extend in the X-axis direction, of the opening 21a are formed as tapered surfaces between which the width is increased as a distance from the support surface 20a in the Z-axis direction is increased. In other words, a distance between the pair of portions in the Y-axis direction is increased in a direction in which the pair of portions become distant from the support plate 20. Accordingly, the light distribution angle of light, which is emitted from the respective light source modules 12, can be controlled by, for example, the angle of the tapered surface of the opening 21a.

The shape of the opening 21a is not limited to a quadrangular shape, may be another polygonal shape, and may be a circular shape, an oval shape, or the like. In this embodiment, the shape of the opening 21a projected on the X-Y plane is a quadrangular shape similar to the outer shape of the frame 21 that is projected on the X-Y plane. The shape of the opening 21a projected on the X-Y plane may be different from the outer shape of the frame 21 that is projected on the X-Y plane.

The cover 22 is provided on the support surface 20a. The cover 22 is mounted on the support plate 20 by, for example, screw-fastening or the like, The cover 22 has the shape of a plate that is bent, for example, in a V shape. For example, a metal material, such as iron, aluminum, or stainless steel, is used for the cover 22. The cover 22 extends, for example, in the X-axis direction and is disposed near the middle of the support surface 20a in the Y-axis direction. The width of the cover 22 in the Y-axis direction is smaller than the width of the opening 21a of the frame 21 in the Y-axis direction. Accordingly, the cover 22 allows, for example, a part of the support surface 20a to be exposed to the outside. In other words, the cover 22 covers, for example, a part of the support surface 20a. The cover 22 allows, for example, the respective light source modules 12, which are mounted on the support plate 20, to be exposed to the outside. Further, the cover 22 closes, for example, mounting holes that are formed in the support plate 20, a hole through which a power cable passes, or the like. Accordingly, for example, the design of the lighting fixture 10 can be improved.

The cover 22 is bent in a V shape. The width of the cover 22 in the Y-axis direction is reduced as a distance from the support surface 20a is increased. Accordingly, the light distribution angle of light, which is emitted from the respective light source modules 12, can be controlled by, for example, the angle of the cover 22. Meanwhile, the power circuit 16 may be disposed, for example, at a position that is covered with the cover 22.

The respective light source modules 12 extend, for example, in the X-axis direction and are lined up in the Y-axis direction. In this embodiment, each of the light source modules 12 has the shape of a substantially rectangular parallelepiped extending in the X-axis direction. In this embodiment, two light source modules 12 are provided between the cover 22 and one portion of the frame 21 extending in the X-axis direction, and two light source modules 12 are provided between the cover 22 and the other portion of the frame 21 extending in the X-axis direction.

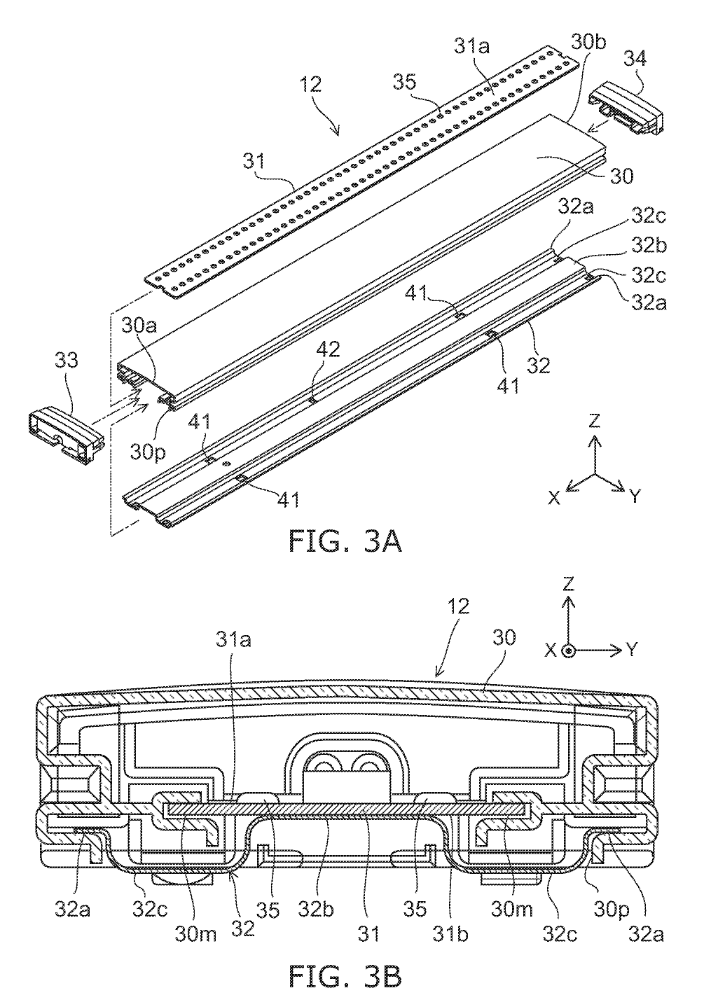

FIGS. 3A and 3B are schematic views showing the light source module according to the embodiment.

FIG. 3A is an exploded perspective view schematically showing the light source module 12, and FIG. 3B is a cross-sectional view schematically showing the light source module 12.

As shown in FIGS. 3A and 3B, the light source module 12 includes a case 30, a substrate 31, a mounting plate 32, and a pair of caps 33 and 34.

The case 30 has the shape of a tube extending in the X-axis direction (first direction). The case 30 has the shape of, for example, a substantially rectangular tube. The case 30 has light transmissivity. For example, a resin material or the like having light transmissivity is used for the case 30. The case 30 may have light transmissivity and light diffusivity like, for example, a milky-white resin, a resin subjected to frosting processing, or the like.

The case 30 includes an opening 30p. The opening 30p has, for example, the shape of a slit extending in the X-axis direction. For example, the opening 30p is continued to one end 30a of the case 30 in the X-axis direction and the other end 30b of the case 30 in the X-axis direction. The opening 30p may not necessarily be continued to one end 30a and the other end 30b.

The substrate 31 extends in the X-axis direction. The shape of the substrate 31 projected on the X-Y plane is, for example, a rectangular shape. The substrate 31 includes a surface 31a and a back 31b opposite to the surface 31a. In this embodiment, the back 31b is substantially parallel to the surface 31a. The back 31b may not be parallel to the surface 31a. A plurality of light sources 35 are provided on the surface 31a of the substrate 31. A wiring pattern (not shown) is formed on the substrate 31. Each of the light sources 35 is electrically connected to the wiring pattern of the substrate 31. For example, the respective light sources 35 are lined up in the X-axis direction and the Y-axis direction. The number or pitch of the respective light sources 35 is arbitrary. The number or pitch of the respective light source 35 may be appropriately determined according to the size of the lighting fixture 10 or brightness required for the lighting fixture 10.

For example, a light emitting diode (LED) is used as the light source 35. For example, the light source 35 may be an organic light emitting diode (OLED), an inorganic electroluminescence light-emitting element, an organic electroluminescence light-emitting element, or other electroluminescence light-emitting elements.

A pair of grooves 30m, which hold the substrate 31, are formed in the case 30. The respective grooves 30m extend in the X-axis direction, and face each other in the Y-axis direction (a second direction orthogonal to the first direction on the plane parallel to the first direction). The height of each groove 30m (the length of each groove 30m in the Z-axis direction) is substantially equal to or slightly larger than the thickness of the substrate 31 (the length of the substrate 31 in the Z-axis direction). The depth of each groove 30m in the Y-axis direction and the interval between the respective grooves 30m in the Y-axis direction are substantially equal to or slightly larger than the width of the substrate 31 in the Y-axis direction.

One end of the substrate 31 in the Y-axis direction is inserted into one groove 30m, and the other end of the substrate 31 in the Y-axis direction is inserted into the other groove 30m. For example, the substrate 31 is inserted into the respective grooves 30m from one end 30a of the case 30 and the substrate 31 slides in the X-axis direction so that the substrate 31 is received in the case 30. Accordingly, the substrate 31 is held in the case 30.

The substrate 31 is held in the case 30 so that the respective light sources 35 face the side opposite to the opening 30p of the case 30. The wiring pattern of the substrate 31 is electrically connected to the power circuit 16 through wires (not shown) while being held in the case 30. Accordingly, each of the light sources 35 is turned on according to the supply of power from the power circuit 16. Light emitted from each of the light sources 35 passes through the case 30 and is emitted to the outside. Accordingly, a room is illuminated by light emitted from the respective light sources 35.

For example, the mounting plate 32 is used to mount the light source module 12 on the support unit 14. For example, the mounting plate 32 has high thermal conductivity and elasticity. For example, the thermal conductivity of the mounting plate 32 is higher than the thermal conductivity of the case 30. The mounting plate 32 is, for example, a metal plate. A metal material, such as iron, aluminum, or stainless steel, is used for the mounting plate 32. The mounting plate 32 may be made of, for example, a resin material having high thermal conductivity such as carbon fiber.

For example, the mounting plate 32 is held by the case 30 while being inserted between the opening 30p and the substrate 31 in the case 30. For example, the mounting plate 32 includes a pair of engaging portions 32a, a contact portion 32b, and a pair of mounting portions 32c. Each of the engaging portions 32a, the contact portion 32b, and each of the mounting portions 32c extend in the X-axis direction. For example, each of the mounting portions 32c is disposed between the respective engaging portions 32a. For example, the contact portion 32b is disposed between the respective mounting portions 32c.

Each of the engaging portions 32a is engaged with the edge portion of the opening 30p while being inserted into the case 30. While each of the engaging portions 32a is engaged with the edge portion of the opening, the contact portion 32b comes into contact with the back 31b of the substrate 31. While each of the engaging portions 32a is engaged with the edge portion of the opening and the contact portion 32b comes into contact with the back 31b of the substrate 31, each of the mounting portions 32c protrudes from the opening 30p to the outside of the case 30. Each of the mounting portions 32c is used to mount the light source module 12 on the support unit 14.

For example, a distance between the engaging portion 32a and the contact portion 32b in the Z-axis direction is slightly longer than a distance between the edge portion of the opening 30p and the back 31b of the substrate 31, which is held by the respective grooves 30m, in the Z-axis direction. Accordingly, when the mounting plate 32 is inserted into the case 30, the mounting plate 32 is interposed between the edge portion of the opening 30p and the back 31b of the substrate 31. Therefore, the mounting plate 32 is held in the case 30. Further, the substrate 31 is pressed against the inner surface of each of the grooves 30m by the elastic force of the mounting plate 32. For example, the mounting plate 32 comes into close contact with the back 31b of the substrate 31. Accordingly, the substrate 31 and the mounting plate 32 can be appropriately held in the case 30 without, for example, screw-fastening or the like.

Since the contact portion 32b comes into contact with the back 31b of the substrate 31, the mounting plate 32 is thermally connected to the substrate 31. Accordingly, for example, the heat, which is generated when each of the light sources 35 is turned on, can be released to the mounting plate 32. For example, the heat dissipation of each of the light sources 35 can be improved. Meanwhile, the contact portion 32b may come into direct contact with the back 31b of the substrate 31, and may come into contact with the back 31b of the substrate 31 with, for example, heat dissipation grease, a heat dissipation sheet, or the like interposed therebetween. As described above, in this specification, “thermally connected” includes not only a case in which the contact portion 32b comes into direct contact with the back 31b of the substrate 31 but also a case in which the contact portion 32b comes into contact with the back 31b of the substrate 31 with heat dissipation grease, a heat dissipation sheet, or the like interposed therebetween.

The cap 33 is fitted to one end 30a of the case 30 and closes one end 30a. The cap 34 is fitted to the other end 30b of the case 30 and closes the other end 30b. Accordingly, the separation of the substrate 31 and the mounting plate 32, which are received in the case 30, from the case 30 is suppressed. For example, a resin material such as rubber having elasticity is used for the caps 33 and 34.

First engaging portions 41 and a second engaging portion 42 are formed at the mounting portions 32c of the mounting plate 32. In this embodiment, a plurality of first engaging portions 41 are formed at each of the mounting portions 32c. In more detail, two first engaging portions 41 are formed at each of the mounting portions 32c, that is, a total of four first engaging portions 41 are formed at the mounting plates 32. Meanwhile, one second engaging portion 42 is formed in this embodiment. The second engaging portion 42 is disposed so as to be lined up together with the first engaging portions 41 in the X-axis direction. The number of the first engaging portions 41 and the number of the second engaging portion 42 are arbitrary.

The support plate 20 is provided with first engaged portions 51 that are engaged with the first engaging portions 41 and second engaged portions 52 that are engaged with the second engaging portions 42 (see FIGS. 2A and 2B). A plurality of first engaged portions 51 are provided so as to correspond to the plurality of first engaging portions 41 formed at the mounting plate 32, respectively. Further, the first and second engaged portions 51 and 52 are provided so as to correspond to the light source modules 12, respectively. That is, sixteen first engaged portions 51 and four second engaged portions 52 are formed at the support plate 20 in this embodiment.

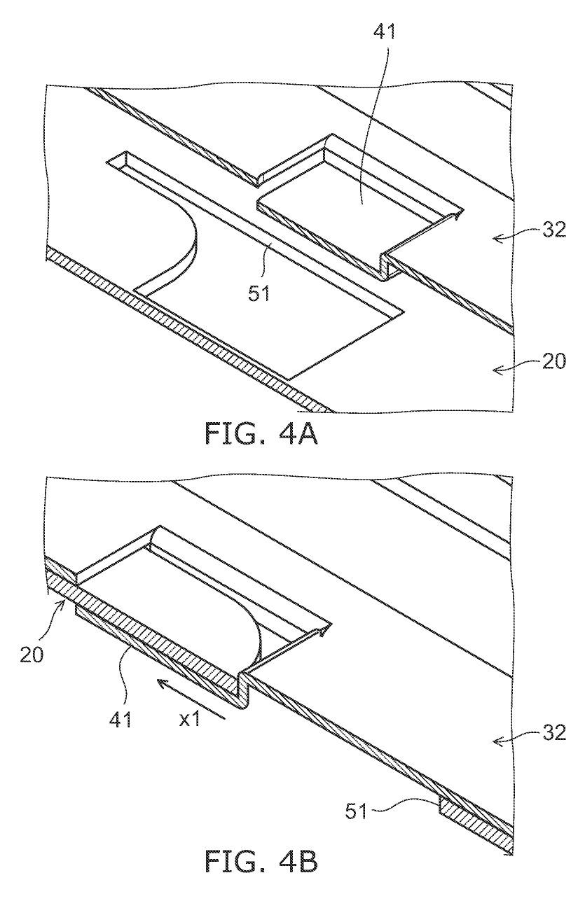

FIGS. 4A and 4B are schematic perspective views showing a part of the support plate and a part of the mounting plate according to the embodiment.

As shown in FIGS. 4A and 4B, the first engaging portion 41 has the shape of a hook. For example, the first engaging portion 41 is formed by forming an L-shaped cut in the mounting plate 32 and extruding the cut portion by press working. For example, the protruding length of the first engaging portion 41 is substantially the same as the thickness of the support plate 20. The first engaged portion 51 is an opening into which the first engaging portion 41 can be inserted. The first engaged portion 51 is formed to have a shape corresponding to the first engaging portion 41.

As shown in FIG. 4B, the first engaging portion 41 is inserted into the first engaged portion 51 and is slid in the X-axis direction. Accordingly, the first engaging portion 41 is engaged with the first engaged portion 51. The movement of the mounting plate 32 relative to the support plate 20 in the Z-axis direction is restricted by the engagement between the first engaging portions 41 and the first engaged portions 51. The movement of the mounting plate 32 relative to the support plate 20 in the Y-axis direction is restricted. In addition, the movement of the mounting plate 32 relative to the support plate 20 toward one side in the X-axis direction is restricted. In this embodiment, the first engaging portion 41 and the first engaged portion 51 restrict the movement of the mounting plate toward the side (one side) that is represented by an arrow x1 parallel to the X-axis direction. Meanwhile, in contrast to the above description, the first engaging portion 41 may be formed in the shape of an opening and the first engaged portion 51 may be formed in the shape of a hook.

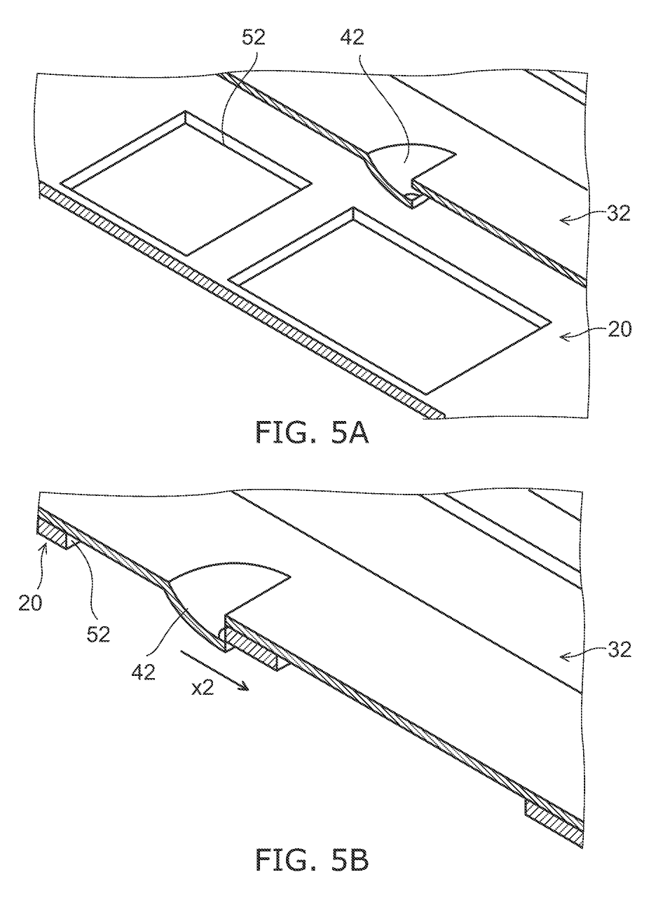

FIGS. 5A and 5B are schematic perspective views showing a part of the support plate and a part of the mounting plate according to the embodiment.

As shown in FIGS. 5A and 5B, the second engaging portion 42 has the shape of a claw. In this embodiment, the second engaging portion 42 has a substantially hemispherical shape and the second engaging portion 42 is formed by being extruded by, for example, press working. The second engaged portion 52 is an opening that is engaged with the second engaging portion 42. The shape of the second engaged portion 52 is formed to have a shape corresponding to the second engaging portion 42.

As shown in FIG. 5B, the second engaging portion 42 is engaged with the second engaged portion 52 when the first engaging portion 41 and the first engaged portion 51 are engaged with each other. Accordingly, the second engaging portion 42 restricts the movement of the mounting plate 32 relative to the support plate 20 toward the other side in the X-axis direction. That is, the second engaging portion 42 restricts the movement of the mounting plate 32 in the X-axis direction toward the side opposite to the first engaging portion 41. In this embodiment, the second engaging portion 42 and the second engaged portion 52 restrict the movement of the mounting plate toward the side (the other side) that is represented by an arrow x2 parallel to the X-axis direction.

Accordingly, the movement of the mounting plate 32 relative to the support plate 20 in the respective directions is restricted by the engagement between the first engaging portions 41 and the first engaged portions 51 and the engagement between the second engaging portions 42 and the second engaged portions 52. Therefore, the light source modules 12 are supported by the support plate 20. For example, the support plate 20 supports the light source modules 12 so that the respective light sources 35 face the side opposite to the support surface 20a. Meanwhile, in contrast to the above description, the second engaging portion 42 may be formed in the shape of an opening and the second engaged portion 52 may be formed in the shape of a claw.

Further, since the light source modules 12 are supported by the support plate 20 as described above, for example, the mounting plates 32 come into contact with the support plate 20. For example, the mounting plates 32 come into close contact with the support plate 20. Accordingly, the mounting plates 32 are thermally connected to the support plate 20. That is, in the lighting fixture 10, the substrates 31, the mounting plates 32, and the support plate 20 are thermally connected to each other. Accordingly, the heat, which is generated by the respective light sources 35, can be released to the support plate 20 through the substrates 31 and the mounting plates 32. Therefore, the heat dissipation of each of the light sources 35 can be further improved.

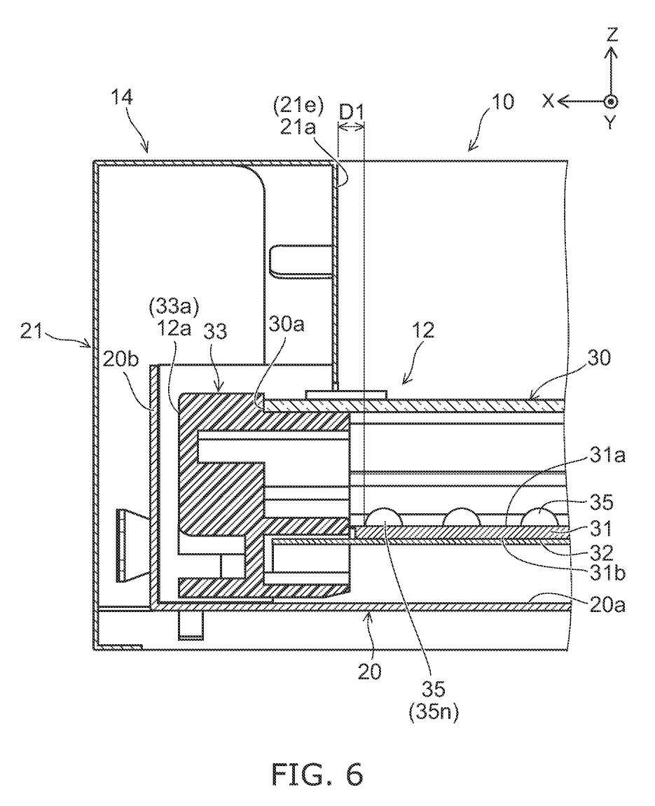

FIG. 6 is a partial cross-sectional view schematically showing a part of the lighting fixture 10 according to the embodiment.

As shown in FIG. 6, an end portion 12a of the light source module 12 in the X-axis direction is covered with the frame 21 while being supported by the support plate 20. In other words, the end portion 12a of the light source module 12 overlaps the frame 21 when being projected on the X-Y plane.

In this embodiment, the end portion 12a of the light source module 12 is an end portion 33a of the cap 33. That is, while the light source modules 12 are supported by the support plate 20, at least the end portion 33a of the cap 33 is covered with the frame 21. Further, an end portion (one end portion 30a) of the case 30 in the X-axis direction is covered with the frame 21 in this embodiment.

The end portion of the case 30 may not necessarily be covered with the frame 21. At least the end portion 12a of the light source module 12 has only to be covered with the frame 21. For example, at least a part of the cap 33 has only to be covered with the frame 21.

Each of the plurality of light sources 35, which is provided on the substrate 31 of the light source module 12, is not covered with the frame 21. Each of the light sources 35 does not overlap the frame 21 when being projected on the X-Y plane. Further, among the respective light sources 35, one light source 35n closest to the end portion 12a of the light source module 12 is disposed close to an end portion 21e of the opening 21a of the frame 21 in the X-axis direction. For example, when being projected on the X-Y plane, the light source 35n is disposed at a position close to the end portion 21e without overlapping the frame 21. A distance D1 between the light source 35n and the end portion 21e in the X-axis direction is in the range of, for example, 1 mm to 50 mm.

FIG. 6 shows the structure of portions of the light source modules 12 close to the cap 33. In the lighting fixture 10, the structure of a portion of the light source module 12 close to the cap 34 is the same as the structure of a portion of the light source module 12 close to the cap 33. That is, an opposite end portion of the light source module 12 in the X-axis direction is covered with the frame 21. An end portion of the cap 34 is covered with the frame 21. In this embodiment, an opposite end portion (the other end 30b) of the case 30 in the X-axis direction is covered with the frame 21. That is, both ends of the light source module 12 in the X-axis direction are covered with the frame 21. Each light source 35 is not covered with the frame 21 even at a position close to the cap 34. Further, for example, another light source 35 closest to the cap 34 is disposed close to the frame 21.

In the lighting fixture 10 according to this embodiment, the end portion 12a of the light source module 12 in the longitudinal direction is covered with the frame 21 and each of the light sources 35 is not covered with the frame 21. Furthermore, the frame 21 has light reflectivity. That is, in the lighting fixture 10, a portion of the light source module 12 between the end portion 12a and the support unit 14 is covered with the frame 21 and hidden. A part of the light emitted from the respective light sources 35 is reflected by the end portion 21e of the opening 21a of the frame 21. Accordingly, the formation of a portion, which has low brightness, for example, between the light source module 12 and the frame 21 can be suppressed in the lighting fixture 10. The formation of portions having low brightness, when seen from, for example, the inside of a room (the opening 21a), can be suppressed in the lighting fixture 10. The brightness of portions of the light source modules 12, which are exposed from the opening 21a when seen from, for example, the inside of a room, can be made substantially uniform in the lighting fixture 10. Accordingly, for example, a good light distribution property can be obtained in the lighting fixture 10. For example, good design can be obtained in the lighting fixture 10.

The thickness of the light source module 12 using light-emitting elements such as LEDs is easily reduced as compared to a fluorescent lamp or the like. Accordingly, when the end portion 12a of the light source module 12 is covered with the frame 21 and hidden, the thickness of the frame 21 can be also reduced. For example, the thickness of the lighting fixture 10 can be reduced.

In the lighting fixture 10, one end 30a and the other end 30b of the case 30 are covered with the frame 21. That is, the caps 33 and 34 are covered with the frame 21 and hidden. Accordingly, the formation of a portion having, for example, low brightness can be more appropriately suppressed. For example, the design of the lighting fixture 10 can be further improved.

In the lighting fixture 10, among the respective light sources 35, one light source 35n closest to the end portion 12a of the light source module 12 is disposed close to an end portion 21e of the opening 21a of the frame 21 in the X-axis direction. Accordingly, the formation of a portion having, for example, low brightness can be more appropriately suppressed.

In the lighting fixture 10, the substrate 31 is held in the case 30 by being inserted into the pair of grooves 30m without screws or the like. Accordingly, vibration or an impact, which is transmitted to the substrate 31, for example, when the lighting fixture 10 falls or the like can be suppressed. Therefore, for example, the breakage, damage, or the like of the substrate 31 or each light source 35 that is caused by vibration, an impact, or the like can be suppressed in the lighting fixture 10. For example, the reduction of the life of the substrate 31 or each light source 35 can be suppressed.

In the lighting fixture 10, the light source modules 12 are supported by the support plate 20 without screws through the engagement between the first engaging portions 41 and the first engaged portions 51 and the engagement between the second engaging portions 42 and the second engaged portions 52. Accordingly, for example, the assemblability of the lighting fixture 10 can be improved. For example, the number of components can be reduced. Further, in the lighting fixture 10, the mounting plates 32 come into close contact with the support plate 20 by the engagement between the first engaging portions 41 and the first engaged portions 51 and the engagement between the second engaging portions 42 and the second engaged portions 52. Accordingly, good heat dissipation can be obtained in the lighting fixture 10. The dissipation of the heat that is generated by the respective light sources 35 can be improved.

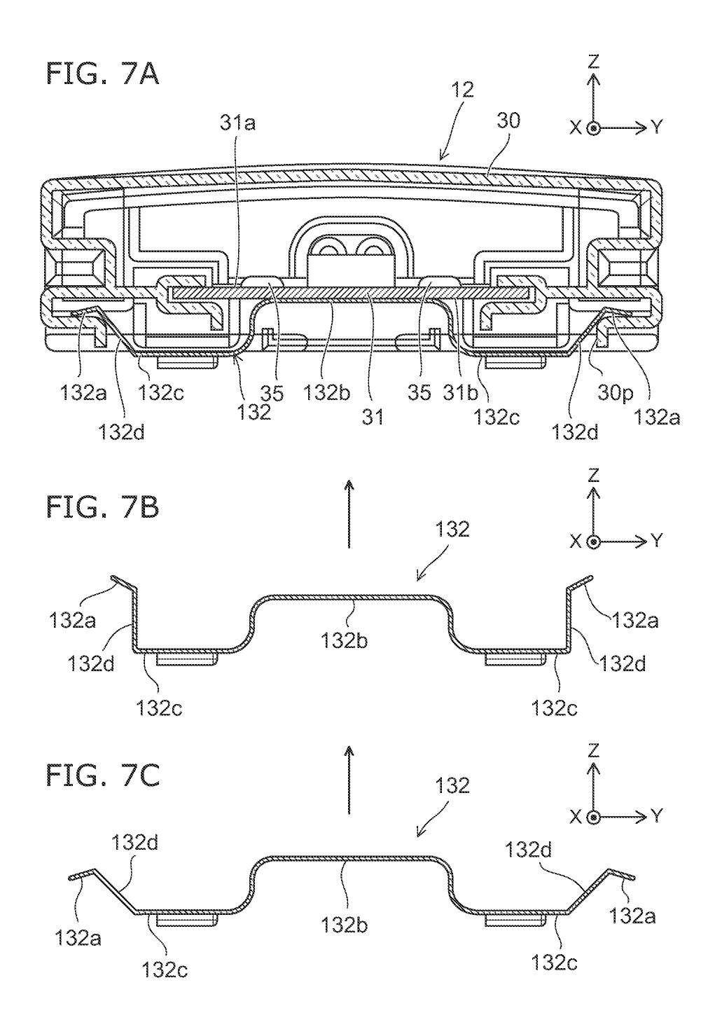

FIGS. 7A to 7C are schematic cross-sectional views showing another light source module according to the embodiment.

As shown in FIGS. 7A to 7C, a mounting plate 132 includes a pair of inclined portions 132d in this embodiment. Each of the inclined portions 132d is disposed between an engaging portion 132a and a mounting portion 132c. Each of the inclined portions 132d is inclined with respect to a direction (Z-axis direction) perpendicular to the surface 31a and the back 31b of the substrate 31. A distance between the respective inclined portions 132d in the Y-axis direction is increased toward the engaging portion 132a from the mounting portion 132c in the Z-axis direction. For example, the distance between the respective inclined portions 132d in the Y-axis direction is continuously increased toward the engaging portion 132a from the mounting portion 132c in the Z-axis direction. That is, the mounting plate 132 is widened toward the engaging portion 132a from the mounting portion 132c in the Z-axis direction. For example, the mounting plate 132 is widened upward.

The mounting plate 132 has elasticity. For example, a metal material is used for the mounting plate 132 as described about the mounting plate 32. The mounting plate 132 is changed into a first state and a second state by being elastically deformed.

FIGS. 7A and 7C show the mounting plate 132 that is in the first state.

FIG. 7B shows the mounting plate 132 that is in the second state.

As shown in FIGS. 7A and 7C, the width of the mounting plate 132, which is in the first state, in the Y-axis direction is larger than the width of the opening 30p in the Y-axis direction. Accordingly, in the first state, each of the engaging portions 132a is engaged with the edge portion of the opening 30p while being inserted into the case 30.

Meanwhile, as shown in FIG. 7B, the width of the mounting plate 132, which is in the second state, in the Y-axis direction is smaller than the width of the opening 30p in the Y-axis direction. The second state is, for example, a state in which the mounting plate 132 is elasticity deformed by a force applied to the mounting plate 132. The first state is, for example, a steady state in which a force is not applied to the mounting plate 132.

As for the mounting plate 32 described about the above-mentioned embodiment, for example, when the mounting plate 32 is mounted in the case 30, the mounting plate 32 is inserted into the case 30 and is slid in the X-axis direction. For this reason, an assembly space corresponding to, for example, a length, which is equal to or longer than double the length of the mounting plate 32 in the X-axis direction, is needed for the mounting plate 32.

In contrast, the mounting plate 132 is bent at the respective inclined portions 132d by elastic deformation as shown in FIG. 7B, so that the mounting plate 132 is in the second state. Accordingly, the mounting plate 132 is inserted into the opening 30p of the case 30 in the Z-axis direction, so that the mounting plate 132 can be mounted on the case 30. Therefore, for example, an assembly space can be saved for the mounting plate 132. For example, the assemblability of the light source module 12 can be improved by the mounting plate 132. For example, the assembly costs of the lighting fixture 10 can be reduced.

The mounting plate 132 is provided with the respective inclined portions 132d, and is widened upward. Accordingly, the mounting plate 132 can be easily changed into the first state and the second state. Further, for example, the respective engaging portions 132a and the respective inclined portions 132d of the mounting plate 132 are pressed against the case 30 by an elastic force that returns to the first state. Accordingly, an upward force is applied along the inclination of each of the inclined portions 132d. Therefore, the contact portion 132b of the mounting plate 132 can more appropriately come into close contact with the back 31b of the substrate 31. For example, the substrate 31 and the mounting plate 132 can be more appropriately held in the case 30. For example, the substrate 31 can be appropriately and thermally connected to the mounting plate 132. For example, the dissipation of the heat that is generated by the respective light sources 35 can be further improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. A lighting fixture comprising:
a light source module including:
a light-transmissive case that has the shape of a tube extending in a first direction and includes an opening extending in the first direction,
a substrate on which a plurality of light sources are provided so as to be lined up and which is held in the case so that the plurality of light sources face the side opposite to the opening, and
a mounting plate that is held by the case while being inserted between the opening and the substrate and is thermally connected to the substrate; and
a support unit including:
a support plate that supports the light source module and is thermally connected to the mounting plate, and
a light-reflective frame that surrounds the outer edge of the support plate,
an end portion of the light source module in the first direction being covered with the frame, and
the respective plurality of light sources being not covered with the frame.

2. The lighting fixture according to claim 1, wherein
the case includes a pair of grooves,
the respective pair of grooves extend in the first direction and face each other in a second direction orthogonal to the first direction on a plane parallel to the first direction, and
the substrate is held in the case by being inserted into the pair of grooves.

3. The lighting fixture according to claim 1, wherein
the mounting plate includes first engaging portions and a second engaging portion,
the support plate includes first engaged portions and a second engaged portion,
the first engaging portions are engaged with the first engaged portions and restrict the movement of the mounting plate relative to the support plate in at least one direction,
when the first engaging portions are engaged with the first engaged portions, the second engaging portion is engaged with the second engaged portion and restricts the movement of the mounting plate relative to the support plate in a direction opposite to the one direction, and
the light source module is supported on the support plate by the engagement between the first engaging portions and the first engaged portions and the engagement between the second engaging portion and the second engaged portion.

4. The lighting fixture according to claim 3, wherein
the first engaging portion has the shape of a hook,
the first engaged portion is an opening into which the first engaging portion is inserted,
the second engaging portion has the shape of a claw, and
the second engaged portion is an opening that is engaged with the second engaging portion.

5. The lighting fixture according to claim 4, wherein
the mounting plate is a metal plate, and
the first engaging portions and the second engaging portion are formed by press working.

6. The lighting fixture according to claim 1, wherein
the mounting plate includes a pair of engaging portions that are engaged with an edge portion of the opening while being inserted into the case, a contact portion that comes into contact with the substrate while the pair of engaging portions are engaged with the edge portion, and a pair of mounting portions that protrude from the opening to the outside of the case while the contact portion comes into contact with the substrate,
the pair of mounting portions are disposed between the pair of engaging portions, and
the contact portion is disposed between the pair of mounting portions.

7. The lighting fixture according to claim 1, wherein
the mounting plate has elasticity and is changed into a first state and a second state by being elastically deformed,
the width of the mounting plate, which is in the first state, is larger than the width of the opening, and
the width of the mounting plate, which is in the second state, is smaller than the width of the opening.

8. The lighting fixture according to claim 7, wherein
the mounting plate includes a pair of engaging portions that are engaged with the edge portion of the opening while being inserted into the case, a contact portion that comes into contact with the substrate while the pair of engaging portions are engaged with the edge portion, a pair of mounting portions that protrude from the opening to the outside of the case while the contact portion comes into contact with the substrate, and a pair of inclined portion that are inclined with respect to a direction perpendicular to a surface of the substrate,
the pair of mounting portions are disposed between the pair of engaging portions,
the contact portion is disposed between the pair of mounting portions,
the pair of inclined portions are disposed between the pair of engaging portions and the pair of mounting portions, respectively, and
a distance between the pair of inclined portions is increased toward the engaging portions from the mounting portions in the direction perpendicular to the surface.

9. The lighting fixture according to claim 1, wherein
the support plate includes a support surface that supports the light source module, a rib that is formed along an outer edge of the support surface, and a side surface that extends in a direction crossing the support surface, and
the frame covers the side surface.

10. The lighting fixture according to claim 1, wherein
the frame includes an opening through which a part of the support plate is exposed to the outside,
the opening includes a pair of portions that extend in the first direction, and
a distance between the pair of portions is increased in a direction in which the pair of portions become distant from the support plate.

11. The lighting fixture according to claim 1, wherein
a plurality of the light source modules are provided,
the support plate includes a support surface that supports the plurality of light source modules, and
the respective plurality of light source modules are parallel to the support surface and are disposed so as to be lined up in a second direction orthogonal to the first direction.

12. The lighting fixture according to claim 11, wherein
the support unit further includes a cover, and
the cover is provided between the plurality of light source modules and covers a part of the support surface.

13. The lighting fixture according to claim 12, wherein
the width of the cover in the second direction is reduced as a distance from the support surface is increased.

14. The lighting fixture according to claim 1, wherein
the light source module further includes a pair of caps that close both ends of the case in the first direction.

15. The lighting fixture according to claim 14, wherein
the frame covers the pair of caps.

16. The lighting fixture according to claim 1, further comprising:
a power circuit that supplies power to the light source module, wherein
the power circuit is mounted on the support plate, and
the frame covers the power circuit.

17. The lighting fixture according to claim 1, wherein
the thermal conductivity of the mounting plate is higher than the thermal conductivity of the case.

18. The lighting fixture according to claim 1, wherein
each of the plurality of light sources is a light emitting diode.

19. The lighting fixture according to claim 1, wherein
the frame includes an opening through which a part of the support plate is exposed to the outside, and
one light source, which is closest to the end portion of the light source module in the first direction, among the plurality of light sources is disposed close to an end portion of the opening of the frame.

20. The lighting fixture according to claim 19, wherein
a distance between the one light source and the end portion of the opening of the frame in the first direction is in the range of 1 mm to 50 mm.
